(19) United States
(12) Patent Application Publication
(10) Pub. No.: US 2024/0012966 A1
(43) Pub. Date: Jan. 11, 2024

(54) METHOD AND SYSTEM FOR PROVIDING A THREE-DIMENSIONAL COMPUTER AIDED-DESIGN (CAD) MODEL IN A CAD ENVIRONMENT

(71) Applicant: Siemens Industry Software Inc., Plano, TX (US)

(72) Inventors: Chinmay Kanitkar, Pune, Maharashtra (IN); Nitin Patil, Pune, Maharashtra (IN)

(21) Appl. No.: 18/022,138

(22) PCT Filed: Aug. 20, 2020
(86) PCT No.: PCT/US2020/047123

§ 371 Date: Feb. 17, 2023

(51) Int. Cl. G06F 30/27

(52) U.S. Cl. CPC G06F 30/27; G06F 2119/20

(57) ABSTRACT

A method and system for providing a three-dimensional Computer-Aided Design (CAD) model of an object in a CAD environment are provided. A method includes receiving a request for a three-dimensional CAD model of a physical object, where the request includes a two-dimensional image of the object. An image vector is generated from the two-dimensional image using a first trained machine learning algorithm. The method includes generating a three-dimensional point cloud model of the object based on the generated image vector using a second trained machine learning algorithm, and generating a three-dimensional CAD model of the object using the three-dimensional point cloud model of the object. The method includes outputting the three-dimensional CAD model of the object on a graphical user interface.

### PRIORITY

This application is the National Stage of International Application No. PCT/US2020/047123, filed Aug. 20, 2020. The entire contents of this document is hereby incorporated herein by reference.

### FIELD OF TECHNOLOGY

The present disclosure relates to the field of computer-aided design (CAD) and, more particularly, to a method and system for providing a three-dimensional computer-aided design model in a CAD environment.

### BACKGROUND

A Computer-aided design application enables users to create a three-dimensional CAD model of a ‘real-world’ object via a graphical user interface. A user may manually perform a number of operations to generate a three-dimensional CAD model of an object through interaction with the graphical user interface. For example, to create a hole in a rectangular block, a user may specify a diameter, location, and length of a hole via the graphical user interface. If the user wants to have holes at a number of locations in the rectangular block, then the user is to select the locations where the hole are to be created. If the same operation is to be performed multiple times on similar entities, the user is to repeat a same activity (e.g., panning, zooming, rotation, selecting, etc.) over and again. Repeating the same operation multiple times may become time consuming and monotonous activity.

Also, some of these operations are carried out based on experience and expertise of the user. Therefore, a beginner or less experienced user may find difficult to perform the operations without having significant exposure to a job role, domain, and industry. Thus, the beginner or less experienced user may make errors while performing the operations on the geometric component. Typically, these errors are identified post design of the geometric component during a design validation process. However, correction of these errors may be cumbersome and time-consuming activity and may also increase time-to-market of the object.

Further, it may be possible that such a three-dimensional CAD model is previously created by same or another user and stored in a geometric model database. Currently known CAD applications may not be able to effectively search for similar three-dimensional CAD models in the geometric model database, resulting in re-designing of three-dimensional CAD model. This may lead to an increased time-to-market of the object.

### SUMMARY

The scope of the present disclosure is defined solely by the appended claims and is not affected to any degree by the statements within this description. The present embodiments may obviate one or more of the drawbacks or limitations in the related art. A method and system for providing a three-dimensional computer-aided design (CAD) model in a CAD environment is disclosed.

In one aspect, a method of providing a three-dimensional computer-aided design (CAD) model of an object in a CAD environment includes receiving a request for a three-dimensional CAD model of an object. The request includes a two-dimensional image of the object. The method includes generating an image vector from the two-dimensional image using a first trained machine learning algorithm. Further, the method includes generating a three-dimensional point cloud model of the object based on the generated image vector using a second trained machine learning algorithm, and generating a three-dimensional CAD model of the object using the three-dimensional point cloud model of the object. Further, the method includes outputting the three-dimensional CAD model of the object on a graphical user interface. The method may include storing the three-dimensional point cloud model and the generated image vector of the two-dimensional image of the object in a geometric model database.

The method may include receiving a request for the three-dimensional CAD model of the object. The request includes a two-dimensional image of the object. The method may include generating an image vector from the two-dimensional image using the first trained machine learning algorithm, and performing a search for the three-dimensional CAD model of the object in a geometric model database consisting of a plurality of three-dimensional CAD models based on the generated image vector. The method may include determining whether the three-dimensional CAD model of the object is successfully found in the geometric model database, and outputting the three-dimensional CAD model of the object on a graphical user interface.

In the act of performing the search for the three-dimensional CAD model of the object in the geometric model database using the third trained machine learning algorithm, the method may include comparing the generated image vector of the two-dimensional image with each image vector associated with the respective three-dimensional CAD models in the geometric model database using the third machine learning algorithm, and identifying the three-dimensional CAD model from the geometric model database based on the best match between the generated image vector and the image vector of the three-dimensional CAD model.

In another aspect, a method of providing a three-dimensional computer-aided design (CAD) model of an object in a CAD environment includes receiving a request for a three-dimensional CAD model of an object. The request includes a two-dimensional image of the object. The method includes generating an image vector from the two-dimensional image using a first trained machine learning algorithm, and performing a search for the three-dimensional CAD model of the object in a geometric model database consisting of a plurality of three-dimensional CAD models based on the generated image vector. The method includes determining whether the requested three-dimensional CAD model of the object is successfully found in the geometric model database, and outputting the requested three-dimensional CAD model of the object on a graphical user interface if the requested three-dimensional CAD model of the object is successfully found in the geometric model database.

The method may include generating a three-dimensional CAD model of the object based on the generated image vector using a second trained machine learning algorithm if the requested three-dimensional CAD model of the object is not found in the geometric model database, and outputting the generated three-dimensional CAD model of the object on the graphical user interface.

In the act of generating the three-dimensional CAD model of the object based on the generated image vector using the second trained machine learning model, the method may include generating a three-dimensional point cloud model of the object based on the generated image vector using the second trained machine learning algorithm, and generating the three-dimensional CAD model of the object using the three-dimensional point cloud model of the object. Further, the method may include storing the generated three-dimensional CAD model of the object and the generated image vector of a corresponding two-dimensional image of the object in the geometric model database.

In the act of performing the search for the three-dimensional CAD model of the object in the geometric model database, the method may include performing the search for the three-dimensional CAD model of the object in the geometric database using a third trained machine learning algorithm.

In the act of performing the search for the three-dimensional CAD model of the object in the geometric model database using the third trained machine learning algorithm, the method may include comparing the generated image vector of the two-dimensional image with each image vector associated with the respective geometric models in the geometric model database using the third machine learning algorithm, and identifying one or more three-dimensional CAD models from the geometric model database based on the match between the generated image vector and the image vector of the one or more three-dimensional CAD models.

The method may include ranking the one or more three-dimensional CAD models based on their match with the requested three-dimensional CAD model of the object, and determining at least one three-dimensional CAD model having an image vector that best matches with the generated image vector of the two-dimensional image based on the ranking of the one or more three-dimensional CAD models. The method may include modifying the determined three-dimensional CAD model based on the generated image vector of the two-dimensional model.

In yet another aspect, a data processing system includes a processing unit, and a memory unit coupled to the processing unit. The memory unit includes a CAD model configured to receive a request for a three-dimensional Computer-Aided Design (CAD) model of an object. The request includes a two-dimensional image of the object. The CAD model is configured to generate an image vector from the two-dimensional image using a first trained machine learning algorithm, and perform a search for the three-dimensional CAD model of the object in a geometric database including a plurality of three-dimensional CAD models based on the generated image vector. The CAD module is configured to determine whether the requested three-dimensional CAD model of the object is successfully found in the geometric model database, and output the requested three-dimensional CAD model of the object on a graphical user interface if the requested three-dimensional CAD model of the object is successfully found in the geometric model database.

The CAD module may be configured to generate a three-dimensional CAD model of the object based on the generated image vector using a second trained machine learning algorithm if the requested three-dimensional CAD model of the object is not found in the geometric model database, and output the generated three-dimensional CAD model of the object on the graphical user interface.

In the act of generating the three-dimensional CAD model of the object based on the generated image vector using the second trained machine learning model, the CAD module may be configured to generate a three-dimensional point cloud model of the object based on the generated image vector using the second trained machine learning algorithm, and generate the three-dimensional CAD model of the object using the three-dimensional point cloud model of the object. The CAD module may be configured to store the generated three-dimensional CAD model of the object and the generated image vector of corresponding two-dimensional image of the object in the geometric model database.

In the act of performing the search for the three-dimensional CAD model of the object in the geometric model database, the CAD module may be configured to perform the search for the three-dimensional CAD model of the object in the geometric database using a third trained machine learning algorithm.

In the act of performing the search for the three-dimensional CAD model of the object in the geometric model database using the third trained machine learning algorithm, the CAD module may be configured to compare the generated image vector of the two-dimensional image with each image vector associated with the respective geometric models in the geometric model database using the third machine learning algorithm, and identify one or more three-dimensional CAD models from the geometric model database based on the match between the generated image vector and the image vector of the one or more three-dimensional CAD models.

The CAD module may be configured to rank the identified three-dimensional CAD models based on their match with the requested three-dimensional CAD model of the object, and determine at least one three-dimensional CAD model having an image vector that best matches with the generated image vector of the two-dimensional image based on the ranking of the one or more three-dimensional CAD models. The CAD module may be configured to modify the determined three-dimensional CAD model based on the generated image vector of the two-dimensional model.

In yet another aspect, a non-transitory computer-readable medium, having machine-readable instructions stored therein that, when executed by a data processing system, cause the data processing system to perform above mentioned method is provided.

This summary is provided to introduce a selection of concepts in a simplified form that are further described below in the following description. The summary is not intended to identify features or essential features of the claimed subject matter. Further, the claimed subject matter is not limited to implementations that solve any or all disadvantages noted in any part of this disclosure.

### BRIEF DESCRIPTION OF THE DRAWINGS

FIG. 1 is a block diagram of an exemplary data processing system for providing a three-dimensional computer-aided design (CAD) model of an object using one or more trained machine learning algorithms, according to one embodiment.

FIG. 2 is a block diagram of a CAD module for providing a three-dimensional CAD model of an object based on a two-dimensional image of the object, according to one embodiment.

FIG. 3 is a process flowchart depicting an exemplary method of generating a three-dimensional CAD model of an object in a CAD environment, according to one embodiment.

FIG. 4 is a process flowchart depicting an exemplary method of generating a three-dimensional CAD model of an object in a CAD environment, according to another embodiment.

FIG. 5 is a process flowchart depicting a method of providing a three-dimensional CAD model of an object in a CAD environment, according to yet another embodiment.

FIG. 6 is a process flowchart depicting a method of providing a three-dimensional CAD model of an object in a CAD environment, according to another embodiment.

FIG. 7 is a schematic representation of a data processing system for providing a three-dimensional CAD model of an object, according to another embodiment.

FIG. 8 illustrates a block diagram of a data processing system for providing three-dimensional CAD models of objects using a trained machine learning algorithm, according to yet another embodiment.

FIG. 9 illustrates a schematic representation of an image vector generation module such as shown in FIG. 2, according to one embodiment.

FIG. 10 illustrates a schematic representation of a model search module such as shown in FIG. 2, according to one embodiment.

FIG. 11 illustrates a schematic representation of a model generation module such as shown in FIG. 2, according to one embodiment.

### DETAILED DESCRIPTION

A method and system for providing a three-dimensional computer-aided design (CAD) model in a CAD environment are provided. Various embodiments are described with reference to the drawings, where like reference numerals are used in reference to the drawings. Like reference numerals are used to refer to like elements throughout. In the following description, numerous specific details are set forth in order to provide a thorough understanding of embodiments. These specific details need not be employed to practice embodiments. In other instances, well known materials or methods have not been described in detail in order to avoid unnecessarily obscuring embodiments. While the disclosure is susceptible to various modifications and alternative forms, specific embodiments thereof are shown by way of example in the drawings and will herein be described in detail. There is no intent to limit the disclosure to the particular forms disclosed. Instead, the disclosure is to cover all modifications, equivalents, and alternatives falling within the spirit and scope of the present disclosure.

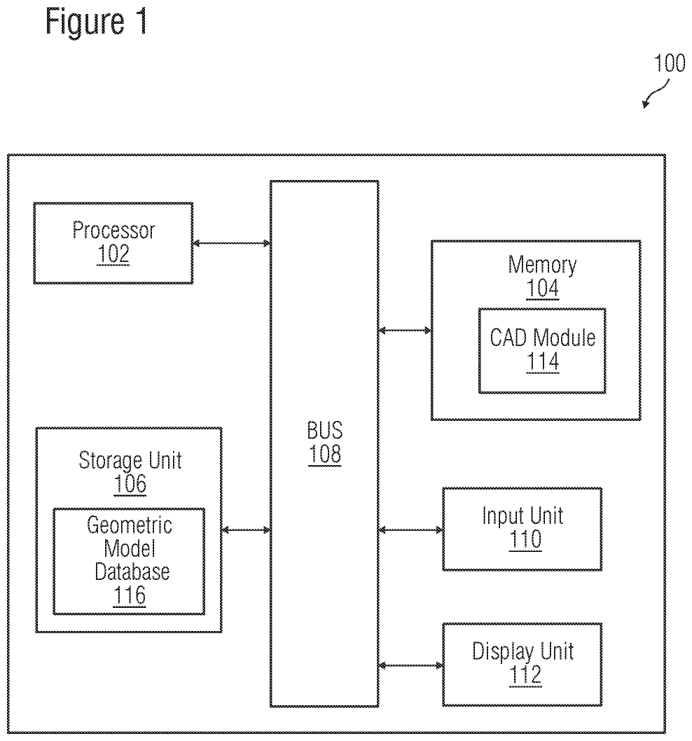

FIG. 1 is a block diagram of an exemplary data processing system 100 for providing a three-dimensional CAD model of an object using one or more trained machine learning algorithm, according to one embodiment. The data processing system 100 may be a personal computer, workstation, laptop computer, tablet computer, and the like. In FIG. 1, the data processing system 100 includes a processing unit 102, a memory unit 104, a storage unit 106, a bus 108, an input unit 110, and a display unit 112. The data processing system 100 is a specific purpose computer configured to provide a three-dimensional CAD model using one or more trained machined learning algorithms.

The processing unit 102, as used herein, may be any type of computational circuit, such as, but not limited to, a microprocessor, microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processing unit 102 may also include embedded controllers, such as generic or programmable logic devices or arrays, application specific integrated circuits, single-chip computers, and the like.

The memory unit 104 may be non-transitory volatile memory and non-volatile memory. The memory unit 104 may be coupled for communication with the processing unit 102, such as being a computer-readable storage medium. The processing unit 102 may execute instructions and/or code stored in the memory unit 104. A variety of computer-readable instructions may be stored in and accessed from the memory unit 104. The memory unit 104 may include any suitable elements for storing data and machine-readable instructions, such as read only memory, random access memory, erasable programmable read only memory, electrically erasable programmable read only memory, a hard drive, a removable media drive for handling compact disks, digital video disks, diskettes, magnetic tape cartridges, memory cards, and the like.

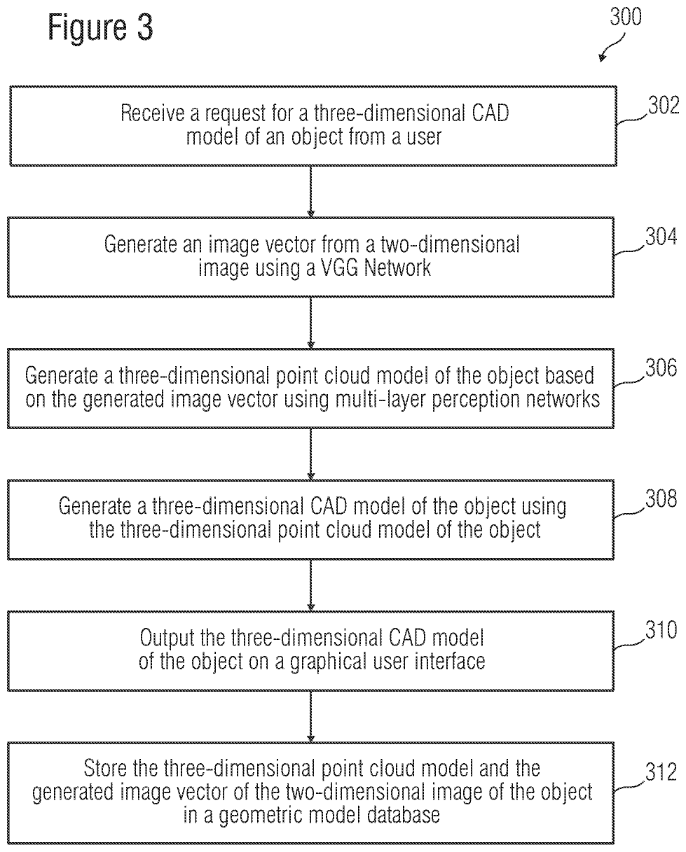

In the present embodiment, the memory unit 104 includes a CAD module 114 stored in the form of machine-readable instructions on any of the above-mentioned storage media and may be in communication to and executed by the processing unit 102. When the machine-readable instructions are executed by the processing unit 102, the CAD module 114 causes the processing unit 102 to generate an image vector from a two-dimensional image of an object using a first trained machine learning algorithm. The two-dimensional (2-D) image may be a photograph of a physical object, a hand drawn sketch, a single view preview of three-dimensional CAD model, and the like. Further, when the machine-readable instructions are executed by the processing unit 102, the CAD module 114 causes the processing unit 102 to perform a search for a three-dimensional CAD model of the object in a geometric database 116 consisting of a plurality of three-dimensional CAD models based on the generated image vector, determine whether the requested three-dimensional CAD model of the object is successfully found in the geometric model database 116, and output the requested three-dimensional CAD model of the object on the display unit 112 if the requested three-dimensional CAD model of the object is successfully found in the geometric model database 116. Also, when the machine-readable instructions are executed by the processing unit 102, the CAD module 114 causes the processing unit 102 to generate a three-dimensional CAD model of the object based on the generated image vector using a second trained machine learning algorithm if the requested three-dimensional CAD model of the object is not found in the geometric model database 116, and output the generated three-dimensional CAD model of the object on the display unit 112. Method acts performed by the processing unit 102 to achieve the above functionality are described in greater detail in FIGS. 3 to 6.

The storage unit 106 may be a non-transitory storage medium that stores a geometric model database 116. The geometric model database 116 stores three-dimensional CAD models along with image vector of two-dimensional images of objects represented by the three-dimensional CAD models. The input unit 110 may include input devices such as keypad, touch-sensitive display, camera (e.g., a camera receiving gesture-based inputs), etc. capable of receiving input signals such as a request for a three-dimensional CAD model of an object. The display unit 112 may be a device with a graphical user interface displaying a three-dimensional CAD model of an object. The graphical user interface may also enable users to select a CAD command for providing a three-dimensional CAD model. The bus 108 acts as interconnect between the processing unit 102, the memory unit 104, the storage unit 106, the input unit 110, and the display unit 112.

Those of ordinary skilled in the art will appreciate that the hardware components depicted in FIG. 1 may vary for particular implementations. For example, other peripheral devices such as an optical disk drive and the like, Local Area Network (LAN)/Wide Area Network (WAN)/Wireless (e.g., Wi-Fi) adapter, graphics adapter, disk controller, input/output (I/O) adapter may also be used in addition to or in place of the hardware depicted. The depicted example is provided for the purpose of explanation only and is not meant to imply architectural limitations with respect to the present disclosure.

The data processing system 100 in accordance with an embodiment of the present disclosure includes an operating system employing a graphical user interface. The operating system permits multiple display windows to be presented in the graphical user interface simultaneously with each display window providing an interface to a different application or to a different instance of the same application. A cursor in the graphical user interface may be manipulated by a user through the pointing device. The position of the cursor may be changed, and/or an event such as clicking a mouse button may be generated to actuate a desired response.

One of various commercial operating systems, such as aversion of Microsoft Windows™ a product of Microsoft Corporation located in Redmond, Washington may be employed if suitably modified. The operating system is modified or created in accordance with the present disclosure as described.

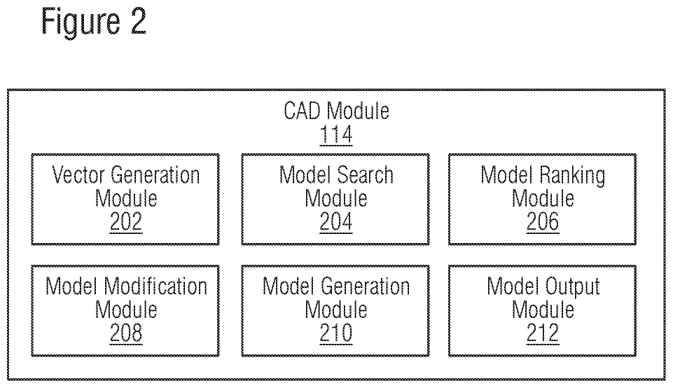

FIG. 2 is a block diagram of the CAD module 114 for providing a three-dimensional CAD model of an object based on a two-dimensional image of the object, according to one embodiment. The CAD module 114 includes a vector generation module 202, a model search module 204, a model ranking module 206, a model modification module 208, a model generation module 210, and a model output module 212.

The vector generation module 202 is configured to generate an image vector of a two-dimensional image of an object. The two-dimensional image is input by a user of the data processing system 100 so that the data processing system 100 may provide a three-dimensional CAD model of the object. In one embodiment, the vector generation module 202 generates a high dimensional image vector of size 4096 from the two-dimensional image using a trained convolutional neural network. For example, the vector generation module 202 preprocess the two-dimensional image to generate a three-dimensional image matrix and transforms the three-dimensional matrix into a high-dimensional image vector using a trained VGG convolutional neural network. In the act of pre-processing the image, the vector generation module 202 resizes the two-dimensional image to [224, 224, 3] and normalizes the resized image to generate a three-dimensional image matrix of size [224, 224, 3]. In some embodiments, the trained VGG convolutional neural network has a stack of convolutional layers followed by two Fully-Connected (FC) layers. The first FC layer accepts three-dimensional image matrix of size [224, 224, 3]. The three-dimensional image matrix is processed through each layer and passed on to the second FC layer in an expected shape. The second FC layer has 4096 channels. The second FC layer transforms the pre-processed three-dimensional image matrix into one-dimensional image vector of size 4096.

The model search module 204 is configured to perform a search for the requested three-dimensional CAD model of the object in the geometric model database 116 based on the generated image vector using a trained machine learning algorithm (e.g., a K-nearest neighbor algorithm 1002 of FIG. 10). The geometric model database 116 includes a plurality of three-dimensional CAD models of objects and corresponding image vectors of two-dimensional images of the objects. In one embodiment, the model search module 204 is configured to compare the image vector of the two-dimensional image with the image vectors corresponding to the plurality of three-dimensional CAD models stored in the geometric model database 116 using the K-nearest neighbor algorithm. In an exemplary implementation, the K-nearest neighbor algorithm indicates probability of each image vector in the geometric model database 116 matching with the generated image vector corresponding to the requested three-dimensional CAD model. For example, the K-nearest neighbor algorithm computes distance of the generated image vector with each image vector in the geometric model database 116 using distance metric such as Euclidean distance. The model search module 204 outputs the image vector with a minimum distance to the generated image vector. The image vector with the minimum distance is considered as the best matching image vector to the generated image vector. Alternatively, the model search module 204 outputs one or more image vectors having a distance with respect to the generated image vector falls in a pre-defined range.

The model search module 204 is configured to identify one or more three-dimensional CAD models from the plurality of three-dimensional CAD models having a respective image vector that best matches with the image vector corresponding to the requested three-dimensional CAD model of the object. In an exemplary implementation, the model search module 204 identifies the one or more three-dimensional CAD models from the plurality of three-dimensional CAD models based on probability values associated with the image vectors corresponding to the one or more three-dimensional CAD models. For example, the model search module 204 may select three-dimensional CAD models if the image vectors corresponding to the three-dimensional CAD models have probability values falling within a pre-defined range (e.g., 0.7 to 1.0).

The model ranking module 206 is configured to rank each of the identified three-dimensional CAD models based on their match with the requested three-dimensional CAD models. In one embodiment, the model ranking module 206 ranks the identified three-dimensional CAD models based on the probability values of the corresponding image vectors. For example, the model ranking module 206 assigns a highest rank to the identified three-dimensional CAD model if the probability of the corresponding image vector matching the image vector of the two-dimensional image is highest. This is due to the fact that the highest probability indicates a best match between the identified three-dimensional CAD model and the requested three-dimensional CAD model. Accordingly, the model ranking module 206 may select one of the identified three-dimensional CAD models having the highest rank as the outcome of search performed in the geometric model database 116.

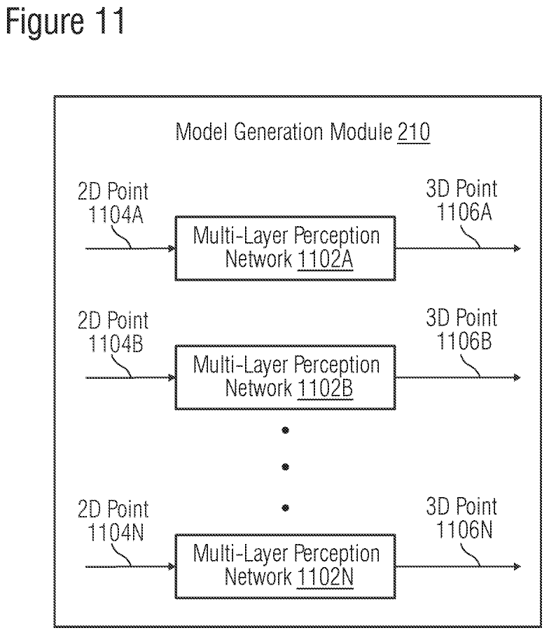

The model modification module 208 is configured to modify the selected three-dimensional CAD model if there is not an exact match between the selected three-dimensional CAD model and the requested three-dimensional CAD model. In one embodiment, the model modification module 208 determines that there is no exact match between the selected three-dimensional CAD model and the requested three-dimensional CAD model if the probability value of the image vector corresponding to the selected three-dimensional CAD model is less than 1.0. The model modification module 208 compares the image vector corresponding to the selected three-dimensional CAD model and the image vector corresponding to the requested three-dimensional CAD model. The model modification module 208 determines two-dimensional points between the image vectors that do not match with each other. The model modification module 208 generates three-dimensional points corresponding to the two-dimensional points based on the image vector of the requested three-dimensional CAD model using yet another trained machine learning algorithm (e.g., multi-layer perception networks 1102A-N of FIG. 11). The model modification module 208 modifies the three-dimensional point cloud model of the selected three-dimensional CAD model using the three-dimensional points. For example, the model modification module 208 modifies the three-dimensional point cloud model by replacing the three-dimensional points with the generated three-dimensional points. Accordingly, the model modification module 208 generates a modified three-dimensional CAD model based on the modified three-dimensional point cloud model of the selected three-dimensional CAD model.

The model generation module 210 is configured to generate a three-dimensional CAD model of the object from the image vector of the two-dimensional image using the yet another trained machine learning algorithm (e.g., the multi-layer perception networks 1102A-N of FIG. 11). In one embodiment, the model generation module 210 is configured to generate the three-dimensional CAD model if the search for the requested three-dimensional CAD model in the geometric model database 116 is unsuccessful. The search for the requested three-dimensional CAD model is unsuccessful if the model search module 204 do not find any best matching three-dimensional CAD model(s) in the geometric model database 116. In an alternate embodiment, the model generation module 210 is configured to generate the three-dimensional CAD model from the image vector without performing a search for the similar three-dimensional CAD model in the geometric model database 116.

In accordance with the foregoing embodiments, the model generation module 210 generates three-dimensional points for each two-dimensional point in the image vector of the two-dimensional image using the yet another trained machine learning algorithm. The model generation module 210 generates a three-dimensional point cloud model based on the three-dimensional points. Accordingly, the model generation module 210 generates the requested three-dimensional CAD model based on the three-dimensional point cloud model.

The model output module 212 is configured to output the requested three-dimensional CAD model on the display unit 112 of the data processing system 100. Alternatively, the model output module 212 is configured to generate a CAD file including the requested three-dimensional CAD model for manufacturing the object using additive manufacturing process. Also, the model output module 212 is configured to store the requested three-dimensional CAD model in a CAD file along with the image vector of the two-dimensional image. Alternatively, the model output module 212 is configured to store the three-dimensional point cloud model in Standard Template Library (STL) format such that the data processing system 100 may reproduce the three-dimensional CAD model based on the three-dimensional point cloud model in STL format.

FIG. 3 is a process flowchart 300 depicting an exemplary method of generating a three-dimensional CAD model of an object in a CAD environment, according to one embodiment. At act 302, a request for a three-dimensional CAD model of a physical object is received from a user of the data processing system 100. The request includes a two-dimensional image of the object. At act 304, an image vector is generated from the two-dimensional image using a VGG network.

At act 306, a three-dimensional point cloud model of the object is generated based on the generated image vector using multi-layer perception networks. At act 308, a three-dimensional CAD model of the object is generated using the three-dimensional point cloud model of the object. At act 310, the three-dimensional CAD model of the object is output on a graphical user interface of the data processing system 100. At act 312, the three-dimensional point cloud model and the generated image vector of the two-dimensional image of the object is stored in a geometric model database 116 in a standard template library format.

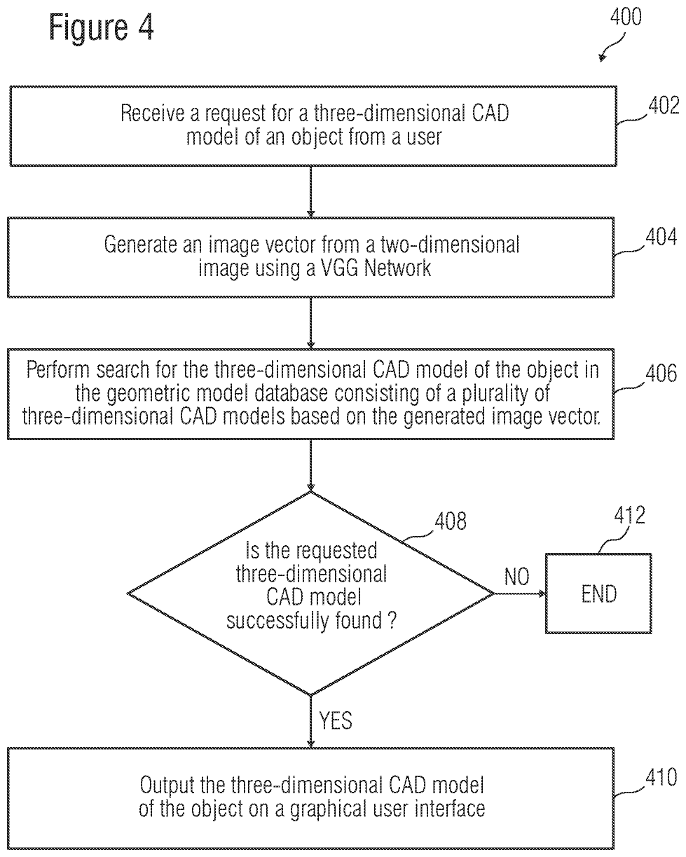

FIG. 4 is a process flowchart 400 depicting an exemplary method of generating a three-dimensional CAD model of an object in a CAD environment, according to another embodiment. At act 402, a request for the three-dimensional CAD model of the object is received from a user of the data processing system 100. The request includes a two-dimensional image of the object. At act 404, an image vector is generated from the two-dimensional image using a VGG network.

At act 406, a search for the requested three-dimensional CAD model of the object is performed in the geometric model database 116 including a plurality of three-dimensional CAD models based on the generated image vector. In some embodiments, the generated image vector of the two-dimensional image is compared with each image vector associated with the respective three-dimensional CAD models in the geometric model database 116 using a K-nearest neighbor algorithm. In these embodiments, the three-dimensional CAD model is identified from the geometric model database based on the best match between the generated image vector and the image vector of the three-dimensional CAD model. At act 408, it is determined whether the three-dimensional CAD model of the object is successfully found in the geometric model database 116. If the three-dimensional CAD model is successfully found in the geometric model database 116, then at act 410, the three-dimensional CAD model of the object is output on a graphical user interface. Otherwise, the process 400 ends at act 412.

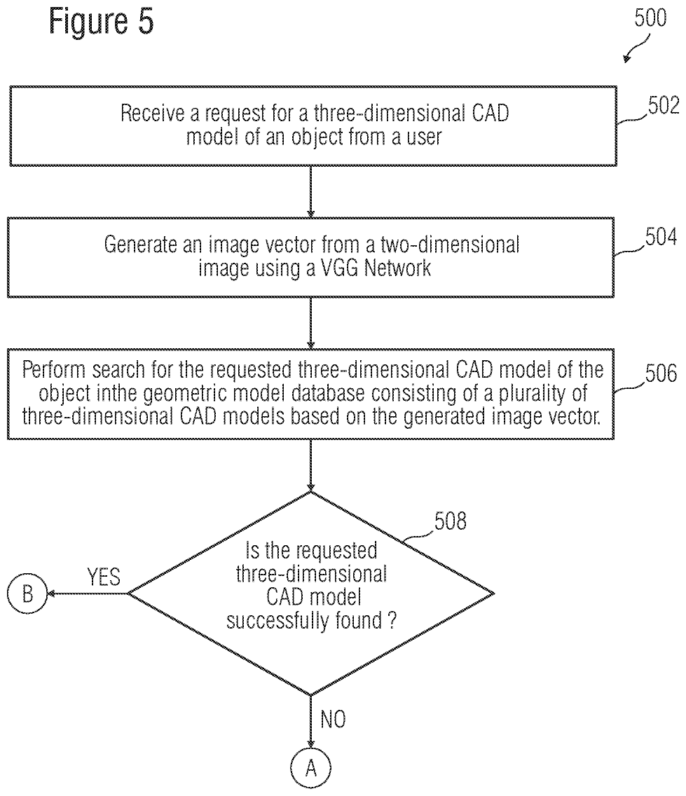

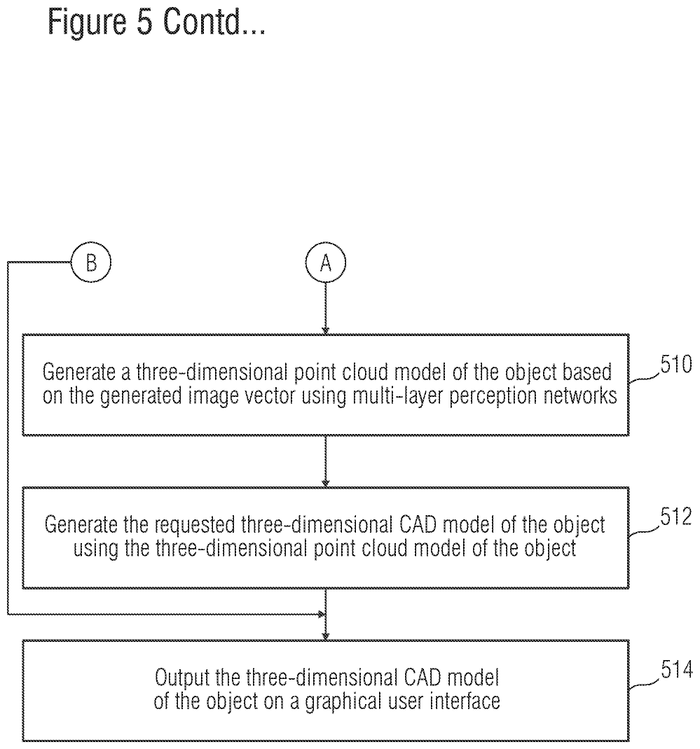

FIG. 5 is a process flowchart 500 depicting a method of providing a three-dimensional CAD model of an object in a CAD environment, according to yet another embodiment. At act 502, a request for a three-dimensional CAD model of an object is received from a user of the data processing system 100. The request includes a two-dimensional image of the object. At act 504, an image vector is generated from the two-dimensional image using a VGG network. At act 506, a search for the requested three-dimensional CAD model of the object is performed in the geometric model database 116 including a plurality of three-dimensional CAD models based on the generated image vector. In some embodiments, the generated image vector of the two-dimensional image is compared with each image vector associated with the respective geometric models in the geometric model database 116 using K-nearest neighbor algorithm. In these embodiments, one or more three-dimensional CAD models are identified from the geometric model database based on the match between the generated image vector and the image vector of the one or more three-dimensional CAD models.

At act 508, it is determined whether the requested three-dimensional CAD model of the object is successfully found in the geometric model database 116. If the requested three-dimensional CAD model of the object is successfully found in the geometric model database 116, then act 18 is performed. At act 514, the requested three-dimensional CAD model of the object is output on a graphical user interface of the data processing system 100. In case one or more three-dimensional CAD models are found, the one or more three-dimensional CAD models are ranked based on the match with the requested three-dimensional CAD model of the object. Accordingly, at least one three-dimensional CAD model having an image vector that best matches with the generated image vector of the two-dimensional image is determined and output based on the ranking of the one or more three-dimensional CAD models. In alternate embodiments, the one or more three-dimensional CAD models are output along with the rank of the one or more three-dimensional CAD models.

If the requested three-dimensional CAD model of the object is not found in the geometric model database 116, at act 510, a three-dimensional point cloud model of the object is generated based on the generated image vector using multi-layer perception networks. At act 512, the three-dimensional CAD model of the object is generated using the three-dimensional point cloud model of the object. At act 514, the three-dimensional CAD model of the object is output on the graphical user interface of the data processing system 100. Additionally, the generated three-dimensional CAD model of the object and the generated image vector of corresponding two-dimensional image of the object are stored in the geometric model database 116 in a standard template library format.

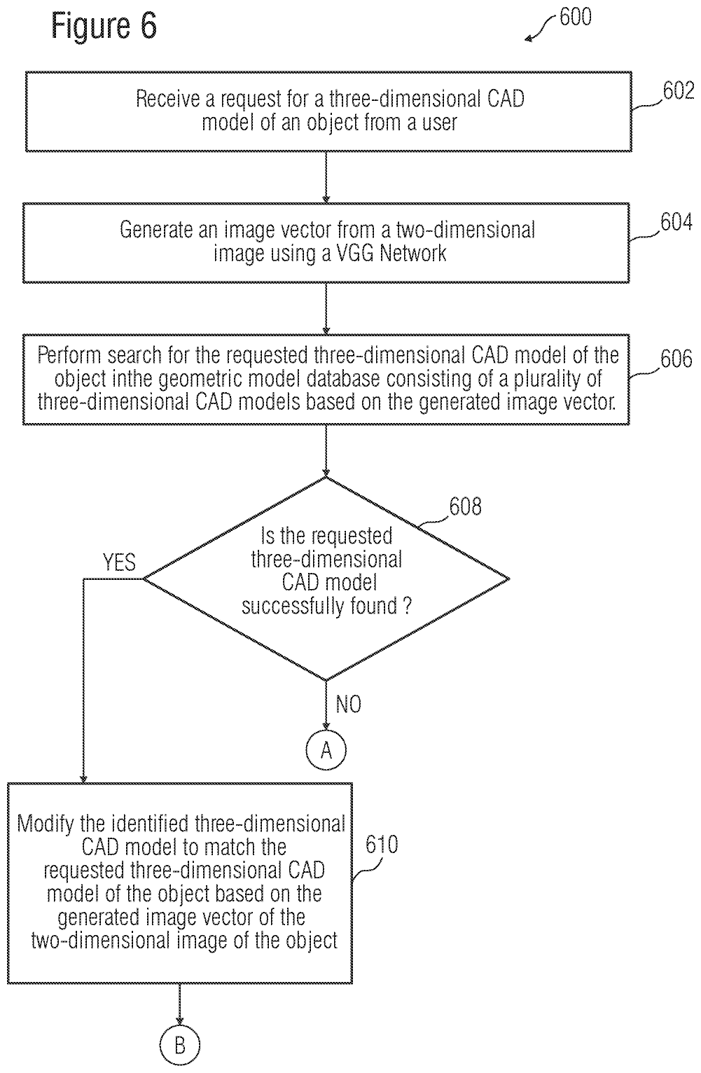

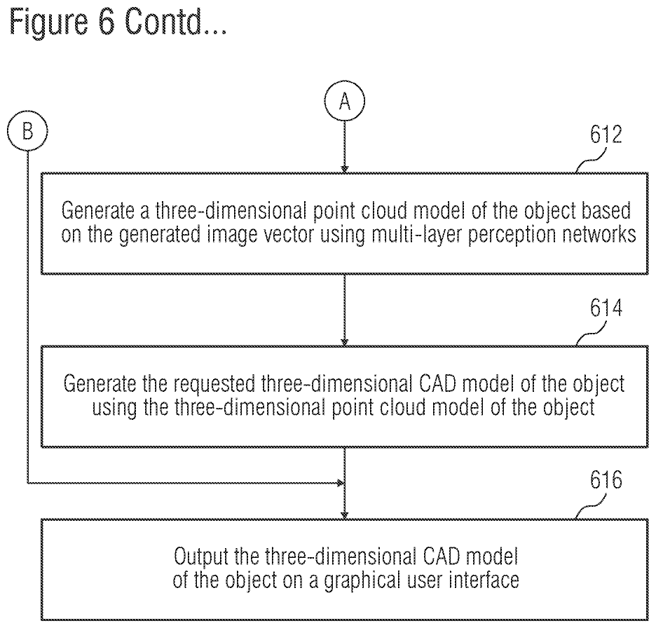

FIG. 6 is a process flowchart 600 depicting a method of providing a three-dimensional CAD model of an object in a CAD environment, according to another embodiment. At act 602, a request for a three-dimensional CAD model of an object is received from a user of the data processing system 100. The request includes a two-dimensional image of the object. At act 604, an image vector is generated from the two-dimensional image using a VGG network. At act 606, a search for the three-dimensional CAD model of the object is performed in the geometric model database 116 consisting of a plurality of three-dimensional CAD models based on the generated image vector. In some embodiments, the generated image vector of the two-dimensional image is compared with each image vector associated with the respective geometric models in the geometric model database 116 using K-nearest neighbor algorithm. In these embodiments, one or more three-dimensional CAD models are identified from the geometric model database based on the match between the generated image vector and the image vector of the one or more three-dimensional CAD models.

At act 608, it is determined whether the requested three-dimensional CAD model of the object is successfully found in the geometric model database 116. If the requested three-dimensional CAD model of the object is successfully found in the geometric model database, at act 610, the identified three-dimensional CAD model is modified to match the requested three-dimensional CAD model of the object based on the generated image vector of the two-dimensional image of the object. In case one or more three-dimensional CAD models are found, the one or more three-dimensional CAD models are ranked based on their match with the requested three-dimensional CAD model of the object. Accordingly, at least one three-dimensional CAD model having an image vector that best matches with the generated image vector of the two-dimensional image is determined based on the ranking of the one or more three-dimensional CAD models. Accordingly, the determined three-dimensional CAD model is modified to match the requested three-dimensional CAD model based on the image vector of the two-dimensional image of the object. At act 616, the requested three-dimensional CAD model of the object is output on a graphical user interface of the data processing system 100.

If the requested three-dimensional CAD model of the object is not found in the geometric model database 116, at act 612, a three-dimensional point cloud model of the object is generated based on the generated image vector using multi-layer perception networks. At act 614, the requested three-dimensional CAD model of the object is generated using the three-dimensional point cloud model of the object. At act 616, the requested three-dimensional CAD model of the object is output on the graphical user interface of the data processing system 100. Additionally, the generated three-dimensional CAD model of the object and the generated image vector of the corresponding two-dimensional image of the object are stored in the geometric model database 116.

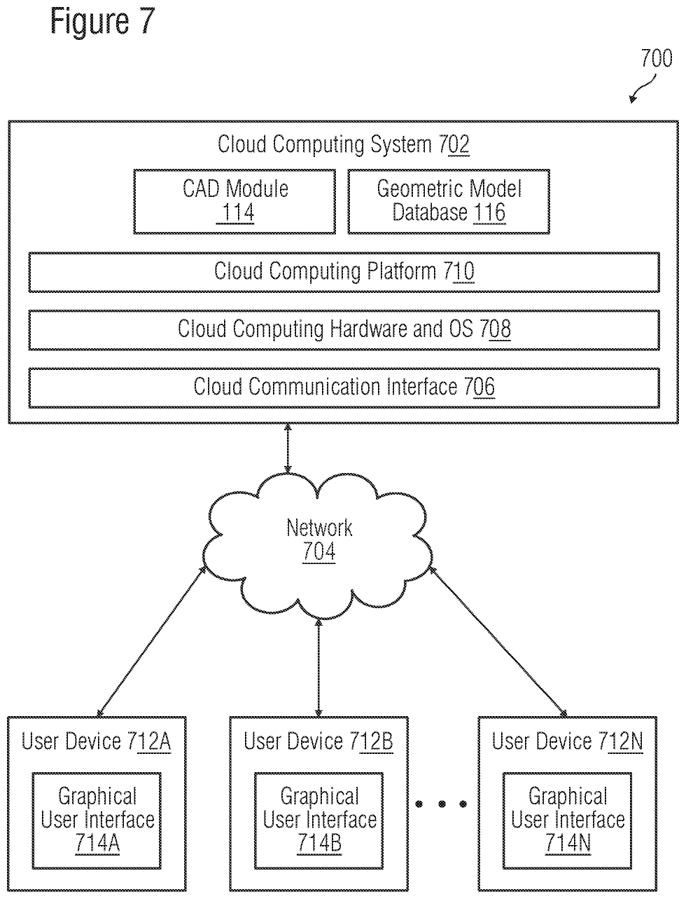

FIG. 7 is a schematic representation of a data processing system 700 for providing a three-dimensional CAD model of an object, according to another embodiment. For example, the data processing system 700 includes a cloud computing system 702 configured for providing cloud services for designing three-dimensional CAD models of objects.

The cloud computing system 702 includes a cloud communication interface 706, cloud computing hardware and OS 708, a cloud computing platform 710, the CAD module 114, and the geometric model database 116. The cloud communication interface 706 enables communication between the cloud computing platform 710 and user devices 712A-N, such as a smart phone, a tablet, a computer, etc. via a network 304.

The cloud computing hardware and OS 708 may include one or more servers on which an operating system (OS) is installed and includes one or more processing units, one or more storage devices for storing data, and other peripherals required for providing cloud computing functionality. The cloud computing platform 710 is a platform that implements functionalities such as data storage, data analysis, data visualization, data communication on the cloud hardware, and OS 708 via APIs and algorithm; and delivers the aforementioned cloud services using cloud based applications (e.g., computer-aided design application). The cloud computing platform 710 employs the CAD module 114 for providing three-dimensional CAD model of an object based on two-dimensional image of the object as described in FIGS. 3 to 6. The cloud computing platform 710 also includes the geometric model database 116 for storing three-dimensional CAD models of objects along with image vector of two-dimensional images of objects.

In accordance with the foregoing embodiments, the cloud computing system 702 may enable users to design objects using trained machine learning algorithm. For example, the CAD module 114 may search for a three-dimensional CAD model of an object in the geometric model database 116 using a trained machine learning algorithm based on image vector of a two-dimensional image of the object. The CAD module 114 may output a best matching three-dimensional CAD model of the object on the graphical user interface. If the geometric model database 116 does not have the requested three-dimensional CAD model, the CAD module 114 generates the requested three-dimensional CAD model of the object using another trained machine algorithm based on the image vector of the two-dimensional image of the object. In one embodiment, the cloud computing system 702 may enable users to remotely access three-dimensional CAD models of objects using two-dimensional image of the objects.

The user devices 712A-N include graphical user interfaces 714A-N for receiving a request for three-dimensional CAD models and displaying the three-dimensional CAD models of objects. Each of the user devices 712A-N may be provided with a communication interface for interfacing with the cloud computing system 702. Users of the user devices 712A-N may access the cloud computing system 702 via the graphical user interfaces 714A-N. For example, the users may send request to the cloud computing system 702 to perform a geometric operation on a geometric component using machine learning models. The graphical user interfaces 714A-N may be specifically configured for accessing the component generation module 114 in the cloud computing system 702.

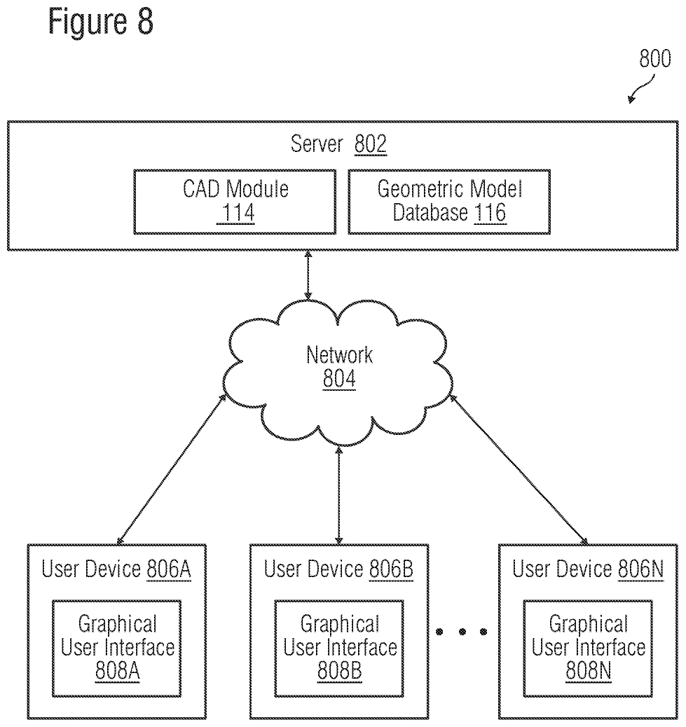

FIG. 8 illustrates a block diagram of a data processing system 800 for providing three-dimensional CAD models of objects using machine learning algorithm, according to yet another embodiment. For example, the data processing system 800 includes a server 802 and a plurality of user devices 806A-N. Each user device of the plurality of user devices 806A-N is connected to the server 802 via a network 804 (e.g., Local Area Network (LAN), Wide Area Network (WAN), Wi-Fi, etc.). The data processing system 800 is another implementation of the data processing system 100 of FIG. 1, where the component generation module 114 resides in the server 802 and is accessed by user devices 806A-N via the network 804.

The server 802 includes the component generation module 114 and the geometric component database 116. The server 802 may also include a processor, a memory, and a storage unit. The CAD module 114 may be stored on the memory in the form of machine-readable instructions and executable by the processor. The geometric component database 116 may be stored in the storage unit. The server 802 may also include a communication interface for enabling communication with client devices 806A-N via the network 804.

When the machine-readable instructions are executed, the component generation module 114 causes the server 802 to search and output three-dimensional CAD models of objects based on two-dimensional images of the objects from the geometric model database 116 using the trained machine learning algorithm, and generate the three-dimensional CAD models of objects using another trained machine learning algorithm if the requested three-dimensional CAD model is not found in the geometric model database 116. Method acts performed by the server 402 to achieve the above-mentioned functionality are described in greater detail in FIGS. 3 to 6.

The client devices 812A-N include graphical user interfaces 814A-N for receiving a request for three-dimensional CAD models and displaying the three-dimensional CAD models of objects. Each of the client devices 812A-N may be provided with a communication interface for interfacing with the cloud computing system 802. Users of the client devices 812A-N may access the cloud computing system 802 via the graphical user interfaces 814A-N. For example, the users may send a request to the cloud computing system 802 to perform a geometric operation on a geometric component using machine learning models. The graphical user interfaces 814A-N may be specifically configured for accessing the component generation module 114 in the cloud computing system 802.

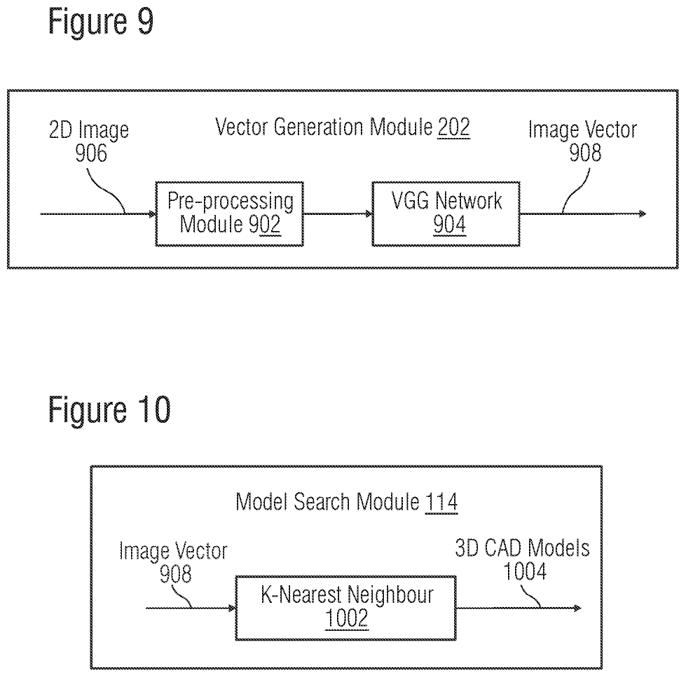

FIG. 9 illustrates schematic representation of the image vector generation module 202 such as those shown in FIG. 2, according to one embodiment. As shown in FIG. 9, the vector generation module 202 includes a pre-processing module 902 and a VGG network 902. The pre-processing module 902 is configured to pre-process a 2-D image 906 of an object by resizing and normalizing the 2-D image 906. For example, the pre-processing module 902 resizes the 2-D image 906 to size 224×224 pixels with 3 channels and normalizes the resized 2-D image with a mean and standard deviation of a VGG network 904 (e.g., Mean=[0.485, 0.456, 0.406], Standard deviation=[0.229, 0.224, 0.225]). The VGG network 904 is configured to transform the pre-processed 2-D image into a high-dimensional latent image vector 908. The VGG network 904 is convolutional neural network trained for transforming normalized 2-D image for size 224×224 pixels with 3 channels into high-dimensional latent image vector 908 of size 4096. The high-dimensional latent image vector 908 represents relevant features from the 2-D image such as edges, corners, colors, textures, and so on.

FIG. 10 illustrates a schematic representation of the model search module 204 such as those shown in FIG. 2, according to one embodiment. As shown in FIG. 10, the model search module 204 employs a K-nearest neighbor algorithm for performing a search for a three-dimensional CAD model of an object requested by a user of the data processing system 100 in the geometric model database 116. The K-nearest neighbor algorithm 1002 may be un-supervised machine learning algorithm such as nearest neighbor with a Euclidean distance metric. The K-nearest neighbor algorithm 1002 performs a search for the requested three-dimensional CAD model in the geometric model database 116 based on the high-dimensional image vector 908 generated by the VGG network 904 of FIG. 9. The geometric model database 116 stores a variety of three-dimensional CAD models along with corresponding high-dimensional image vectors 908. In an exemplary implementation, the K-nearest neighbor algorithm 1002 compares the high-dimensional image vector 908 with high-dimensional image vectors in the geometric model database 116. The K-nearest neighbor algorithm 1002 identifies best matching high-dimensional image vector(s) from the geometric model database 116. The model search module 204 retrieves and outputs three-dimensional CAD model(s) 1004 corresponding to the best matching high-dimensional image vector(s) from the geometric model database 116.

FIG. 11 illustrates a schematic representation of the model generation module 210 such as those shown in FIG. 2, according to one embodiment. As shown in FIG. 11, the model generation module 210 employs multi-layer perception networks 1102A-N to generate a new three-dimensional CAD model of an object based on the high-dimensional image vector 908 of the two-dimensional image of the object. In some embodiments, the model generation module 210 generates the new three-dimensional CAD model of the object when the model search module 204 is unable to find any best matching three-dimensional CAD model in the geometric model database 116.

In an exemplary implementation, the multi-layer perception networks 1102A-N generate the three-dimensional points 1106A-N corresponding to the two-dimensional points 1104A-N in the high-dimensional image vector 908. Two-dimensional points representing the object are sampled uniformly in unit square space. The high dimensional image vector 908 is concatenated with sampled two-dimensional points to form the two-dimensional points 1104A-N.

The model generation module 210 generates a three-dimensional point cloud model by converting the two-dimensional points 1104A-N in the high dimensional image vector 908 into the three-dimensional points 1106A-N. The model generation module 210 generates the new three-dimensional CAD model of the object based on the three-dimensional point cloud model.

The multi-layer perception networks 1102A-N includes five fully connected layers of size 4096, 1024, 516, 256, and 128 with rectified linear units (ReLU) on the first four layers than on the last fifth layer (e.g., output layer). The multi-layer perception networks 1102A-N is trained to generate N number of three-dimensional surface patch points from input data (e.g., the image vector concatenated with sampled two-dimensional points). The trained multi-layer perception networks 1102A-N is evaluated with Chamfer distance loss by measuring difference between the generated three-dimensional surface patch points with closest ground truth three-dimensional surface patch points. The training of the multi-layer perception networks 1102A-N when the difference between the generated three-dimensional surface patch points with closest ground truth three-dimensional surface patch point is within acceptable limit or negligible. In one embodiment, the trained multi-layer perception networks 1102A-N may accurately generate three-dimensional surface patch points corresponding to two-dimensional points in image vector of a two-dimensional image of an object.

The system and methods described herein may be implemented in various forms of hardware, software, firmware, special purpose processing units, or a combination thereof. One or more of the present embodiments may take a form of a computer program product including program modules accessible from computer-usable or computer-readable medium (e.g., non-transitory computer-readable storage medium) storing program code for use by or in connection with one or more computers, processing units, or instruction execution system. For the purpose of this description, a computer-usable or computer-readable medium may be any apparatus that may contain, store, communicate, propagate, or transport the program for use by or in connection with the instruction execution system, apparatus, or device. The medium may be an electronic, magnetic, optical, electromagnetic, infrared, or semiconductor system (or apparatus or device), or a propagation mediums in and of themselves as signal carriers are not included in the definition of physical computer-readable medium including a semiconductor or solid state memory, magnetic tape, a removable computer diskette, random access memory (RAM), a read only memory (ROM), a rigid magnetic disk, optical disk such as compact disk read-only memory (CD-ROM), compact disk read/write, digital versatile disc (DVD), or any combination thereof. Both processing units and program code for implementing each aspect of the technology may be centralized or distributed (or a combination thereof) as known to those skilled in the art.

While the present disclosure has been described in detail with reference to certain embodiments, the present disclosure is not limited to those embodiments. In view of the present disclosure, many modifications and variations would present themselves, to those skilled in the art without departing from the scope of the various embodiments of the present disclosure, as described herein. The scope of the present disclosure is, therefore, indicated by the following claims rather than by the foregoing description. All changes, modifications, and variations coming within the meaning and range of equivalency of the claims are to be considered within the scope.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A method of providing a three-dimensional computer-aided design (CAD) model of an object in a CAD environment, the method comprising:
receiving, by a data processing system, a request for a three-dimensional CAD model of a physical object, wherein the request comprises a two-dimensional image of the physical object;
generating an image vector from the two-dimensional image using a first trained machine learning algorithm, wherein generating the image vector comprises pre-processing the two-dimensional image to generate a three-dimensional image matrix and transforming the three-dimensional image matrix into a high-dimensional image vector using a trained VGG convolutional neural network;
generating three-dimensional points for each two-dimensional point in the generated image vector using a second trained machine learning algorithm;
generating a three-dimensional point cloud model of the physical object based on the generated three-dimensional points;
generating a three-dimensional CAD model of the physical object using the three-dimensional point cloud model of the physical object; and
outputting the three-dimensional CAD model of the physical object on a graphical user interface.

2. The method of claim 1, further comprising:
storing the three-dimensional point cloud model and the generated image vector of the two-dimensional image of the physical object in a geometric model database.

3. The method of claim 2, further comprising:
receiving a request for a three-dimensional CAD model of the object, wherein the request comprises a two-dimensional image of the object;
generating an image vector from the two-dimensional image using the first trained machine learning algorithm;
performing a search for the three-dimensional CAD model of the object in a geometric model database comprising a plurality of three-dimensional CAD models based on the generated image vector;
determining whether the three-dimensional CAD model of the object is successfully found in the geometric model database; and
outputting the three-dimensional CAD model of the object on a graphical user interface.

4. The method of claim 3, wherein performing the search for the three-dimensional CAD model of the object in the geometric model database using a third trained machine learning algorithm comprises:
comparing the generated image vector of the two-dimensional image with each image vector associated with respective three-dimensional CAD models of the plurality of three-dimensional CAD models in the geometric model database using the third machine learning algorithm; and
identifying the three-dimensional CAD model from the geometric model database based on a best match between the generated image vector and the image vector of the three-dimensional CAD model.

5. A method of providing a three-dimensional computer-aided design (CAD) model of an object in a CAD environment, the method comprising:
receiving, by a data processing system, a request for a three-dimensional CAD model of an object, wherein the request comprises a two-dimensional image of the object;
generating an image vector from the two-dimensional image using a first trained machine learning algorithm, wherein generating the image vector comprises pre-processing the two-dimensional image to generate a three-dimensional image matrix and transforming the three-dimensional image matrix into a high-dimensional image vector using a trained VGG convolutional neural network;
performing a search for the three-dimensional CAD model of the object in a geometric model database comprising a plurality of three-dimensional CAD models based on the generated image vector;
determining whether the requested three-dimensional CAD model of the object is successfully found in the geometric model database; and
outputting the requested three-dimensional CAD model of the object on a graphical user interface when the requested three-dimensional CAD model of the object is successfully found in the geometric model database.

6. The method of claim 5, further comprising:
generating a three-dimensional CAD model of the object based on the generated image vector using a second trained machine learning algorithm when the requested three-dimensional CAD model of the object is not found in the geometric model database; and
outputting the generated three-dimensional CAD model of the object on the graphical user interface.

7. The method of claim 6, wherein generating the three-dimensional CAD model of the object based on the generated image vector using the second trained machine learning model comprises:
generating a three-dimensional point cloud model of the object based on the generated image vector using the second trained machine learning algorithm; and
generating the three-dimensional CAD model of the object using the three-dimensional point cloud model of the object.

8. The method of claim 7, further comprising:
storing the generated three-dimensional CAD model of the object and the generated image vector of the two-dimensional image of the object in the geometric model database.

9. The method of claim 5, wherein performing the search for the three-dimensional CAD model of the object in the geometric model database comprises:
performing the search for the three-dimensional CAD model of the object in the geometric model database using a third trained machine learning algorithm.

10. The method of claim 9, wherein performing the search for the three-dimensional CAD model of the object in the geometric model database using the third trained machine learning algorithm comprises:
comparing the generated image vector of the two-dimensional image with each image vector associated with respective geometric models of the plurality of three-dimensional CAD models in the geometric model database using the third machine learning algorithm; and
identifying one or more three-dimensional CAD models of the plurality of three-dimensional CAD models from the geometric model database based on a match between the generated image vector and the respective image vector of the one or more three-dimensional CAD models.

11. The method of claim 10, further comprising:
ranking the one or more three-dimensional CAD models based on the match with the requested three-dimensional CAD model of the object; and
determining at least one three-dimensional CAD model of the one or more three-dimensional CAD models having an image vector that best matches with the generated image vector of the two-dimensional image based on the ranking of the one or more three-dimensional CAD models.

12. The method of claim 11, further comprising:
modifying the at least one determined three-dimensional CAD model based on the generated image vector of the two-dimensional model.

13. A data processing system comprising:
a processing unit; and
a memory unit coupled to the processing unit, wherein the memory unit comprises a CAD module configured to:
receive a request for a three-dimensional Computer-Aided Design (CAD) model of an object, wherein the request comprises a two-dimensional image of the object;
generate an image vector from the two-dimensional image using a first trained machine learning algorithm, wherein the generation of the image vector comprises pre-process of the two-dimensional image, such that a three-dimensional image matrix is generated, and transformation of the three-dimensional image matrix into a high-dimensional image vector using a trained VGG convolutional neural network;
perform a search for the three-dimensional CAD model of the object in a geometric database comprising a plurality of three-dimensional CAD models based on the generated image vector;
determine whether the requested three-dimensional CAD model of the object is successfully found in the geometric model database; and
output the requested three-dimensional CAD model of the object on a graphical user interface when the requested three-dimensional CAD model of the object is successfully found in the geometric model database.

14. The data processing system of claim 13, wherein the CAD module is configured to:
generate a three-dimensional CAD model of the object based on the generated image vector using a second trained machine learning algorithm when the requested three-dimensional CAD model of the object is not found in the geometric model database; and
output the generated three-dimensional CAD model of the object on the graphical user interface.

15. The data processing system of claim 14, wherein in the generation of the three-dimensional CAD model of the object based on the generated image vector using the second trained machine learning model, the CAD module is further configured to:
generate a three-dimensional point cloud model of the object based on the generated image vector using the second trained machine learning algorithm; and
generate the three-dimensional CAD model of the object using the three-dimensional point cloud model of the object.

16. The data processing system of claim 15, wherein the CAD module is further configured to:
store the generated three-dimensional CAD model of the object and the generated image vector of the two-dimensional image of the object in the geometric model database.

17. The data processing system of claim 13, wherein in the performance of the search for the three-dimensional CAD model of the object in the geometric model database, the CAD module is further configured to:
perform the search for the three-dimensional CAD model of the object in the geometric database using a third trained machine learning algorithm.

18. The data processing system of claim 17, wherein in the performance of the search for the three-dimensional CAD model of the object in the geometric model database using the third trained machine learning algorithm, the CAD module is further configured to:
compare the generated image vector of the two-dimensional image with each image vector associated with respective geometric models of the plurality of three-dimensional CAD models in the geometric model database using the third machine learning algorithm; and
identify one or more three-dimensional CAD models of the plurality of three-dimensional CAD models from the geometric model database based on a match between the generated image vector and the respective image vector of the one or more three-dimensional CAD models.

19. The data processing system of claim 18, wherein the CAD module is further configured to:
rank the identified one or more three-dimensional CAD models based on the match with the requested three-dimensional CAD model of the object; and
determine at least one three-dimensional CAD model of the one or more three-dimensional CAD models having an image vector that best matches with the generated image vector of the two-dimensional image based on the ranking of the one or more three-dimensional CAD models.

20. The data processing system of claim 19, wherein the CAD module is further configured to:
modify the at least one determined three-dimensional CAD model based on the generated image vector of the two-dimensional model.
